(19) United States
(12) Patent Application Publication
(10) Pub. No.: US 2020/0141179 A1
(43) Pub. Date: May 7, 2020

(54) AUTOMATIC APPARATUS AND AUTOMATIC METHOD FOR HIGH-PRODUCTIVITY PRODUCTION OF THE INSULATING GLAZING UNIT CONSTITUTED BY AT LEAST TWO GLASS SHEETS AND AT LEAST ONE SPACER FRAME

(71) Applicant: FOREL SPA, RONCADE (IT)

(72) Inventors: Fortunato VIANELLO, RONCADE (IT); Riccardo VIANELLO, RONCADE (IT)

(21) Appl. No.: 16/626,406

(22) PCT Filed: Apr. 26, 2018
(86) PCT No.: PCT/EP2018/060806

§ 371 Date: Dec. 24, 2019

(30) Foreign Application Priority Data
Jun. 27, 2017 (IT) 102017000071422

(51) Int. Cl. E06B 3/673; E06B 3/66; E06B 3/663

(52) U.S. Cl. CPC E06B 3/67369; E06B 3/6612; E06B 3/66342; E06B 2003/6638; E06B 3/66366; E06B 3/6733; E06B 3/6617; E06B 3/67373

(57) ABSTRACT

A high-productivity line for the automatic production of panels of an insulating glazing unit composed of at least two glass sheets and at least one spacer frame interposed between the glass sheets in a peripheral position, which delimit a closed internal volume in which the air is usually replaced with a gas and delimit an outer peripheral region or joint, along which one or more sealing/adhesive products applied between the faces of the glass sheets and of the spacer frame give tightness and stability to the joint, of the glass sheets at least one, indicated as of the second type, being subjected to a smaller quantity of processes than the other or others of the glass sheets, indicated as of the first type, the sheet or sheets of the glass sheets of the second type, subjected to the smaller quantity of processes, converging, by means of an oscillating conveyor, from a secondary line for the washing process in a main line for the process of edging, washing, laying of the spacer frame, optional closing of its fourth corner in the case of a flexible profile, placement of a grille only where and when their involvement begins, jointly with the glass sheets of the first type, in the composition of the insulating glazing unit.

### FIELD OF APPLICATION

The field of application is the one set out in the preamble of Claim 1.

### BACKGROUND ART

Currently, it is known to deposit the spacer frame or spacer profile on a glass sheet and then couple the assembly to a second glass sheet and seal it along the entire outer peripheral region so as to constitute the so-called insulating glazing unit or double glazing.

The operation can be also multiple in order to obtain a multi-chamber insulating glazing unit constituted by three glass sheets and two spacer frames or profiles, as well as n glass sheets and n−1 spacer frames or profiles.

The operation can also relate to glass sheets that have different dimensions although they belong to the same insulating glazing unit so as to obtain an offset between their edges, which is required to mate with a particular type of door or window, i.e., the one that constitutes so-called continuous glazing or so-called structural glazing.

In greater detail, the spacer frame or more properly the profile that constitutes it has an almost rectangular hollow transverse cross-section and is coated on its sides that adhere to the glass sheets with a butyl sealant.

It can be also constituted by a continuous profile, with an essentially rectangular cross-section, which is flexible and made of expanded synthetic material coated on its sides with an acrylic adhesive and optionally also with a butyl sealant.

Currently, it is increasingly widespread to replace the air contained in the volume defined by the glass sheets and by the spacer frame, a volume known as “chamber”, with a gas having better thermal insulation and optionally sound insulation characteristics than air.

This is becoming increasingly relevant because of the prescriptions of technical laws regarding energy saving.

In order to better understand the configuration of the insulating glazing unit 1 in the combination of its components, such as the glass sheets and the spacer frame or the spacer profile, some concepts are described more extensively hereinafter which relate to the semi-finished products themselves, i.e., the glass sheet 2 and the spacer frame or profile 3 and the final product itself, i.e., the insulating glazing unit 1, assuming that the subsequent use of the insulating glazing unit, i.e., as a component of the door or window or of the curtain walling or the structural faces is known.

In order to organize the description it is easier to start in any case from the final product and then break it down into its constitutive elements.

The insulating glazing unit 1 is constituted by the composition of two or more glass sheets 2 separated by one or more spacer frames 3, which are generally hollow and microperforated on the face directed inward, the spacer frames containing in their hollow part hygroscopic material 4 and being provided with a butyl sealant 5 on the lateral faces (which constitutes the so-called first seal) and the chamber (or chambers) delimited by the glass sheets 2 and by the spacer frame (frames) 3 being able to contain air or gas 7, typically Argon or Krypton or gas mixtures 7 that give the double glazing unit particular properties, for example thermal insulation and/or soundproofing properties. Recently, the use has also become widespread of a spacer profile 3 having an essentially rectangular cross-section, made of expanded synthetic material (by way of non-limiting example: silicone and EPDM), which incorporates in its mass the hygroscopic material 4 and is provided on its sides with an adhesive 8 of the PSA (Pressure Sensitive Adhesive) type, typically an acrylic one, and optionally also a sealant of the PIB (polylsobutylene) type, termed “butyl” typically and in the jargon, as further explained in detail hereinafter.

The joining between glass sheets 2 and spacer frame (frames) 3 is obtained by means of two sealing levels, the first one 5 having the function of providing tightness and initial bonding between these components and involving the lateral surfaces of the frame and the portions of the adjacent glazings, which was already mentioned earlier, the second one 6 having the function of providing permanent cohesion among the components and mechanical strength of the joint between them and involving the compartment constituted by the outer surface of the spacer frame 3 and by the faces of the glass sheets 2 up to their edge (see FIG. 1).

In the case of a spacer profile 3 made of expanded synthetic material, the first level of sealing is replaced or integrated by an adhesive 8, for example an acrylic one, already spread on the lateral faces of the same spacer profile 3 and covered by a removable protective film, as commercially available.

The glass sheets 2 used in the composition of the insulating glazing unit 1 may have different shapes in relation to the use of said unit; for example, the outer glazing (outer being understood with respect to the building) can be normal or reflective or selective (in order to limit the thermal load during summer months) or layered (also known as laminated)/armored (for intrusion prevention/vandalism prevention functions) or layered/toughened (for security functions) or combined (for example, reflective and layered in order to obtain a combination of properties), the inner glazing (inner being understood with respect to the building) can be normal or low-emissivity (in order to limit heat dispersion during winter months) or layered/toughened (for security functions) or combined (for example low-emissivity and layered in order to obtain a combination of properties).

In particular, the outer glass sheet 2M can be larger than the inner one (or ones) 2m along the entire extension of the perimeter or only on one side or on some sides (see FIG. 1).

The “low-emissivity” or “reflective” or “selective” properties of the glass sheets are given by means of coatings performed via nanotechnology-based processes of sputter deposition, the overall thicknesses of the coatings, which in any case are multilayer, being on the order of 300 Ångström (symbol Å), but such coatings need to be removed at the regions of interaction of the primary and secondary sealants.

From the simple summary given, it is already clear that a manufacturing line for obtaining the insulating glazing unit product 1 requires many processes in a cascade and in particular comprises the process of perimetric removal of the nanotechnology-based coating, the process of application of the spacer frame and sometimes the process of insertion of decorative grilles within the outline of the spacer frame, processes which do not involve all the glass sheets 2 designed to compose the insulating glazing unit 1 but only some of them (let us define them as of the first type) and in any case in an alternated sequence with the other glass sheets 2 not affected by these processes (let us define them as of the second type).

The processes, established in the background art, for producing the insulating glazing unit 1, each requiring a corresponding and particular machine arranged generally in series with respect to the other complementary ones, are therefore, by way of non-limiting example and at the same time not all necessary, the following:

EDGING (CR) on the peripheral face of the glass sheet 2 in order to remove any coatings (or better nano-coatings, since they are of the type obtained with nanotechnology-based techniques) so as to allow and maintain over time the bond and therefore the effectiveness of the sealants;

GRINDING of the sharp edge of the glazing both to eliminate the margin defects introduced with the cutting operation and to reduce the risks of injuries in progressive handlings both of the glass sheets 2 and the insulating glazing unit 1; and also, in some cases, in order to give a precise geometry both in the dimensions of the glass sheet 2 and in its transverse perimetric profile;

WASHING (VW) of the individual glass sheets, generally alternating inner glazing/outer glazing (the orientation being the one defined previously);

PLACEMENT OF THE SPACER FRAME (TSS): the rigid spacer frame 3, previously manufactured, filled with hygroscopic material 4 having the function of absorbing the humidity incorporated in the chamber during the manufacturing process and any humidity that might subsequently penetrate, and coated on the lateral faces with a thermoplastic sealant 5 having sealing functions, in machines which are outer with respect to the production line of the insulating glazing unit 1, is applied to one of the glass sheets 2, typically the second one (and the following ones in the case of an insulating glazing unit 1 composed of more than two glass sheets 2 and more than one spacer frame 3), which constitute the insulating glazing unit 1, in an adapted station of the production line of the insulating glazing unit 1; in the case of a flexible spacer profile 3 having a substantially rectangular cross-section, made of synthetic material and provided on its sides with PSA adhesive 8 and optionally with PIB sealant 5, it is applied automatically by means of a robotized head right on the second glass sheet 2 (and the subsequent ones, in view of what has already been stated in the case of the rigid frame), so as to constitute the spacer frame 3;

INSERTION OF DECORATIVE GRILLES (GA): the decorative grille 9, if required, previously manufactured, is applied manually, coupling it to the frame 3, in a station upstream of the machine that performs the coupling of the various glass sheets; these grilles 9 are known: in the Italian jargon as “inglesine”, in the United Kingdom jargon as “Georgian bars”, in the United States jargon as “grids”.

FILLING WITH GAS, COUPLING AND PRESSING (APG) of the glass sheets 2/frame (frames) 3 unit;

one of the most widespread solutions for replacing the air with a gas having higher thermal insulation properties is to perform the process during the coupling step of the glass sheets 2 and of the spacer frame 3 or spacer frames 3 (in the case of multi-chamber insulating glazing units); this occurs, as known, in the machine commonly known as “press coupler with gas filling”, the operational logic of which determines the sequence of the glass sheets 2.

This machine is essentially constituted by two planes with a slightly inclined arrangement with respect to the vertical, of which one is fixed and aligned with the conveyors for conveying the glass sheets 2 and the insulating glazing unit 1 and one is movable according to a direction that is orthogonal with respect to said planes; the movable plane, provided with an array of suckers distributed over the entire plane, approaches the fixed one, where the first glass sheet 2 of the B type, i.e., without a spacer frame, was previously placed, until it rests on it, even forcefully so as to straighten it and capture it by means of the activated suckers; thus, said mobile plane moves away from the fixed plane and with it so does the first B-type glass sheet, until it frees a space equal to the bulk of the second glass sheet 2 of the A type, i.e., including the spacer frame 3, which adheres to the same sheet thanks to the first butyl sealant 5, or to the acrylic adhesive 8, or to the combination of butyl sealant 5 and acrylic adhesive 8, plus, in the following step, the space occupation of a slit intended for the subsequent inflow of the gas 7; as the second A-type glass sheet provided indeed with a spacer frame 3 is arranged by means of the conveyors on the fixed plane, suitable known mechanisms move closer the manifold for introducing the gas at the base of the elements that will constitute the insulating glazing unit 1 and other mechanisms, also known, provide two vertical sealing barriers at the sides of the elements that constitute the insulating glazing unit 1, even if with a shape other than the rectangular one; then the gas 7 is injected; then the movable plane closes toward the fixed plane, providing the coupling of the glass sheets 2 and of the spacer frame 3 and concurrent pressing; in this manner, the gas 7 remains trapped inside the insulating glazing unit 1; then the evacuation of the insulating glazing unit 1 containing the gas other than air occurs; in the case of an insulating glazing unit 1 constituted by more than two glass sheets 2 (typically three or four) and more than one spacer frame 3 (typically two or three), the machine, before expelling the insulating glazing unit 1, as composed in the steps described above, performs a further cycle, i.e., the movable plane opens again as described above, retaining said incomplete insulating glazing unit, waits for the positioning of a third glass sheet 2 of the A′ type, i.e., provided with a second spacer frame 3, it moves closer to it as described above and after the introduction of the gas 7 performs a second coupling and a second pressing; the method can be repeated in the case of a quadruple glazing, et cetera.

SECOND SEALING (SAHM) of the set of components: glass sheets 2, spacer frame (frames) 3, at the perimeter, said perimeter being followed by the automatic sealing head by means of the relative motion of the head/insulating glazing unit 1, with dispensing of the elastomeric or thermoplastic sealant 6.

The search of patent prior art filed in the same rather crowded field and disclosing machines and methods for the composition of the insulating glazing unit 1 leads to several inventions, all of which now are so-called free or open background art; therefore, and in order to advance in innovations, currently all manufacturers of these apparatuses, so-called lines, in which the glass sheets have a substantially vertical arrangement (typically inclined by 5÷10 degrees regarding to the vertical), as will be described in detail hereinafter, are facing a further challenge: the high productivity of the lines themselves, and therefore they are devising assuredly new and inventive solutions related to the logic of the flow of the components of the insulating glazing unit 1, particularly of the glass sheets 2 of the first and second type, as defined before the analysis of the processes, the synchronization among the various machines and the adoption of particular devices in such lines which are adapted to nearly double their productivity.

This research has led to two quite recent patent titles and to a disclosure at an exhibition, which are the following:

# US 2015/0354266 A1, with U.S. priority dated Jun. 5, 2014, in the name of Erdman Automation Corporation, related to a device and a method for altering the sequence of the glass sheets of the first type and of the glass sheets of the second type using shuttles to move toward and from rear conveyors, which are parallel to the front ones, the glass sheets of the second type, so that substantially a rear secondary line is configured which is parallel to the front main line, at least at the machine bodies, which therefore remain dedicated to the processing only of the glass sheets of the first type and are not disturbed by the transit of the glass sheets of the second type.

# US 2015/0007433 A1, with German priority dated Jan. 13, 2012, extension of international application WO 2013/000058 dated Jan. 10, 2013, in the name of Plus Inventia AG, related to a device for altering the sequence of the glass sheets of the first type and of the glass sheets of the second type by resorting to conveyors and machine bodies arranged in a book-like configuration, so that glass sheets of the first and second type can also coexist in a mutually opposite arrangement.

# whereas as regards the manufacturer Peter Lisec GmbH, which probably protected the solution with a patent application that is currently in its period of confidentiality, the sequence of the glass sheets of the first type and of the glass sheets of the second type is altered by lifting those of the second type to a higher level, where conveyors which are coplanar to the main ones of the line allow to advance said glass sheets in a bridge-like manner, while at the lower level the machine performs the process on the glass sheets of the first type.

Although the known techniques deriving from these recent prior art documents achieve the goal of increasing productivity, they are affected respectively by some important limitations.

Erdman Automation Corporation:

near-duplication of the conveyors of the line and addition of at least two shuttles, with the consequence of a considerable increase in machinery cost; moreover, difficulties in the removal of any residues of glass sheets that might break along the rear conveyors; moreover, the sheets of the second type do not bypass the edging machine but pass through it.

Plus Inventia AG:

considerable complexity of the press coupler body, which is already per se complex, since it has to be provided also with a tilting axis; large quantity of book-type conveyors; cumulatively, therefore, a significant increase in machinery cost; moreover, difficulty in removal of any residues of glass sheets that might break along the book-type conveyors; moreover, the sheets of the second type do not bypass the edging machine but pass through it.

Peter Lisec GmbH:

considerable complexity of the bypass bridges with consequent increase in machinery cost; need to isolate the front of the line with fixed barriers and with interlocked movable barriers, since in case of breakage of the glass sheets that translate along the upper conveyors or in a situation of any instability of the glass sheets that translate along the upper conveyors (non-flatness, vibrations, seismic actions, etcetera) the crashing to the ground of said sheets or of their fragments would cause injuries to people and damage to property; moreover, the sheets of the second type do not bypass the edging machine but transit through it; moreover, in the high-productivity function, limitation of the height of the glass sheets that can be processed because the conveyors have to manage two superimposed glass sheets.

Furthermore, common to all three known techniques, the management, both in terms of information (IT, data base, data entry), and in operational terms (feeding of the production line of the insulating glazing unit, logistics), is complex and susceptible to criticalities the solution of which is only with the grasp of IT specialists.

This occurs because it is necessary to process, in the sequence, more glass sheets of the second type belonging to different insulating glazing units and more glass sheets of the first type belonging to different insulating glazing units; moreover, the insulating glazing units can have various shapes (single chamber, multiple chamber, with rigid frame, with flexible frame, with grilles, without grilles, with gas, without gas, with aligned or offset glass sheets, with beveled or non-beveled glass sheets, etcetera, as listed in the introductory part of the description and exemplified in FIG. 1 discussed below) and the sequence of the glass sheets generally is ordered not by homogeneity of type but by destination logic (i.e., with the criterion of progressively saturate the bills of the types required customer by customer).

### DESCRIPTION OF THE INVENTION

In the description that follows, the components of the finished product, the insulating glazing unit 1, are identified with single-digit numbering, optionally followed by a letter; known machines are identified with two or more descriptive alphabetic characters; the innovative line parts are designated by an alphabetic character; the parts related to the principle of differentiation from the background art and of innovation are identified with three-digit numbering, optionally followed by a letter; when two zeros are present, they designate the main assembly.

The aim of the present application is therefore to devise an automatic apparatus and an automatic method that allow to substantially increase (approximately double) the productivity of the traditional production line of an insulating glazing unit 1 and to eliminate the problems of high-productivity lines occurring in the recent background art described and commented above.

This has been achieved by devising the solution of not making the glass sheets termed of the second type bypass, along the production line of the insulating glazing unit, the processes that do not involve them, by means of alternative paths, but of shaping the same insulating glazing unit production line with a Y-shaped or T-like merging between the flow of the glass sheets termed of the first type, which follow the main direction and are subjected to an additional series of processes (typically: edging, application of the spacer frame, optional closing of their fourth corner in the case of a flexible profile, insertion of the grille), and the flow of the glass sheets of the second type, which are not involved in these processes.

The optimum merging point “Y” turns out to be the one directly upstream of the gas filling/coupling/pressing machine.

From this point onward, the processes shared by the glass sheets 2 of the first type and the glass sheets 2 of the second type are only the one performed by said machine and the one performed by the sealing machine, plus some residual processes such as, for example, labeling.

The consequent advantages are:

# reduction of the cycle time of each processing station upstream of said Y-shaped merging, since the transit time of the glass sheets of the second type has been eliminated;

# shortening of said first part of the line, since transfer shuttles are not necessary;

# a single station is sufficient for the application of the frame or of the flexible spacer profile (in contrast with the two stations of high-productivity lines according to the background art);

# usability of the Y-shaped node not only for its main function of insertion of the glass sheets 2 termed of the second type but also for expelling the glass sheets 2 termed of the first type or of the second type contaminated by defects that preclude their use.

# usability of the Y-shaped node not only for its main function of insertion of the glass sheets 2 of the second type but also for the reversal of the face of the glass sheet provided with nanotechnology-based coating for cases such as the one shown in FIGS. 1F and 1H, in which one of the two sheets must be rotated since the edging station operates only toward the face that is oriented forward, or for cases such as triple insulating glazing units provided with both low-emissivity coating and selective coating;

# operational simplifications in loading the glass sheets, since it is not necessary to intercalate, in the myriad of mutual combinations, glass sheets of the first type with glass sheets of the second type; moreover, the high-productivity lines of the described background art already require two operators, since the glass sheets must be supplied at a rate of one every 8 seconds and by selecting their type, and therefore it is better if these operators are stationed in the two different areas of the Y-shaped line;

# simplification, therefore, also in factory logistics, since the glass sheets 2 of the first type and the glass sheets 2 of the second type have different origins, particularly for cutting operations;

# simplification in terms of production planning and information systems, since the intercalated management of the glass sheets 2 of the first type and of the second type in the steps ahead of coupling is avoided.

However, this solution entails two washing stations, in contrast with the single one of the background art, but in any case using machines that are less powerful and less bulky, since each one has to process a mostly halved quantity (such is the case of the single-chamber insulating glazing unit) of glass sheets.

The use of personnel for loading remains in any case unchanged and for each operator assigned to loading the activity is less stressful because it is relieved of the need from extreme care in the selection of the type of glass sheets 2 to be loaded.

### DESCRIPTION OF THE DRAWINGS

FIG. 1 is a schematic view of the peripheral portion of the insulating glazing unit 1 in an exemplifying non-exhaustive series of possible combinations (the inside/outside orientation refers to the building): 1A double glazing (single chamber), 1B triple glazing (multiple chamber), 1C layered outer glazing, low-emissivity inner glazing; 1D reflective toughened outer glazing, low-emissivity layered inner glazing; 1E offset layered outer glazing, low-emissivity inner glazing (non-spread protruding portion), both glazings beveled along the entire perimeter; 1F offset and selective layered outer glazing (spread protruding portion), low-emissivity inner glazing; 1G like 1A but with the indication of the containment of gas 7 and both glazings beveled along the entire perimeter; 1H like 1A but with the spacer profile made of expanded synthetic material with the faces coated only with PSA adhesive, moreover comprising an internal grille and moreover with the inner glass sheet of the type with low-emissivity nanotechnology-based coating and with the outer glass sheet of the type with selective nanotechnology-based coating, both glazings beveled along the entire perimeter; 1L like 1A but with a spacer profile made of expanded synthetic material with the faces coated with PSA adhesive and PIB sealant.

FIGS. 1A-1G show the spacer frame 3 in its hollow transverse cross-section filled with hygroscopic material 4.

The two types of sealant used are highlighted: in black the butyl sealant 5 (first seal), having the function of initial bonding among the components and of seal both against the entry of humidity and the exit of the gas other than air applied between the lateral surfaces of the spacer frame 3 and the glazings 2, dashes indicating the polysulfide or polyurethane or silicone sealant 6 (second seal) having a mechanical strength function and sometimes, depending on the type of sealant, also acting as a seal both against the entry of humidity and the exit of the gas other than air applied between the outer surface of the spacer frame 3 and the faces of the glass sheets 2 up to the edge of the glass sheets 2 or to the edge of the glass sheet 2m having smaller dimensions.

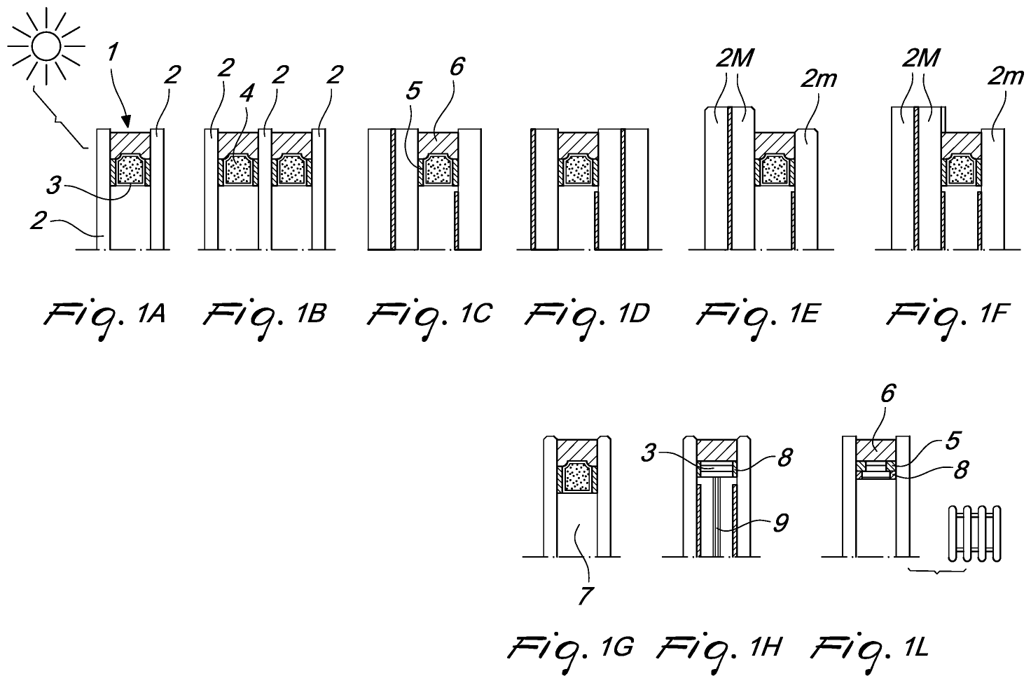

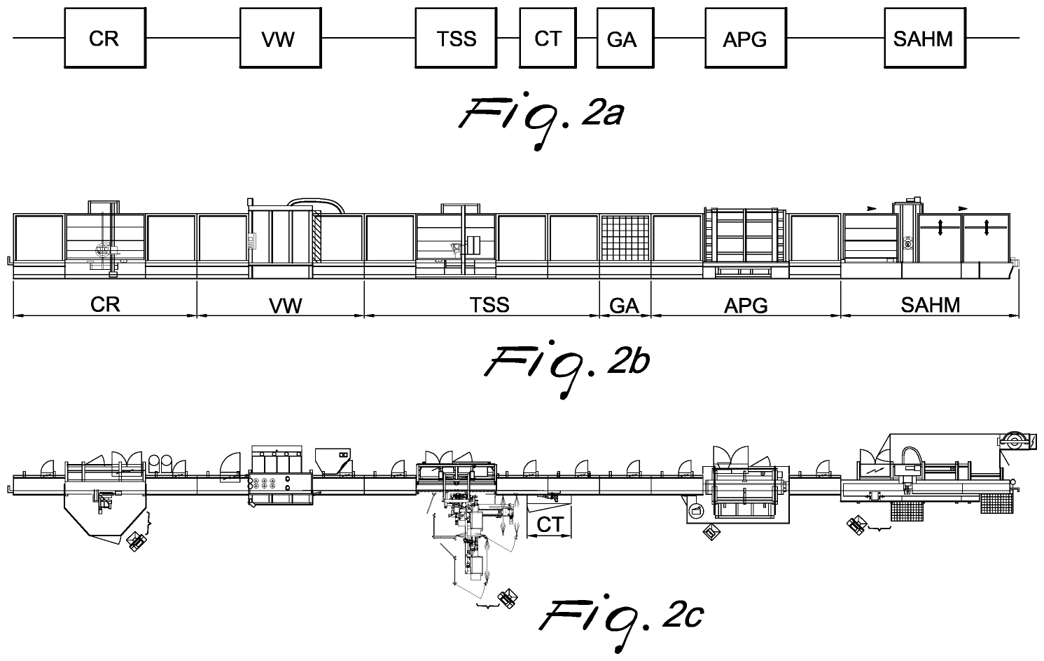

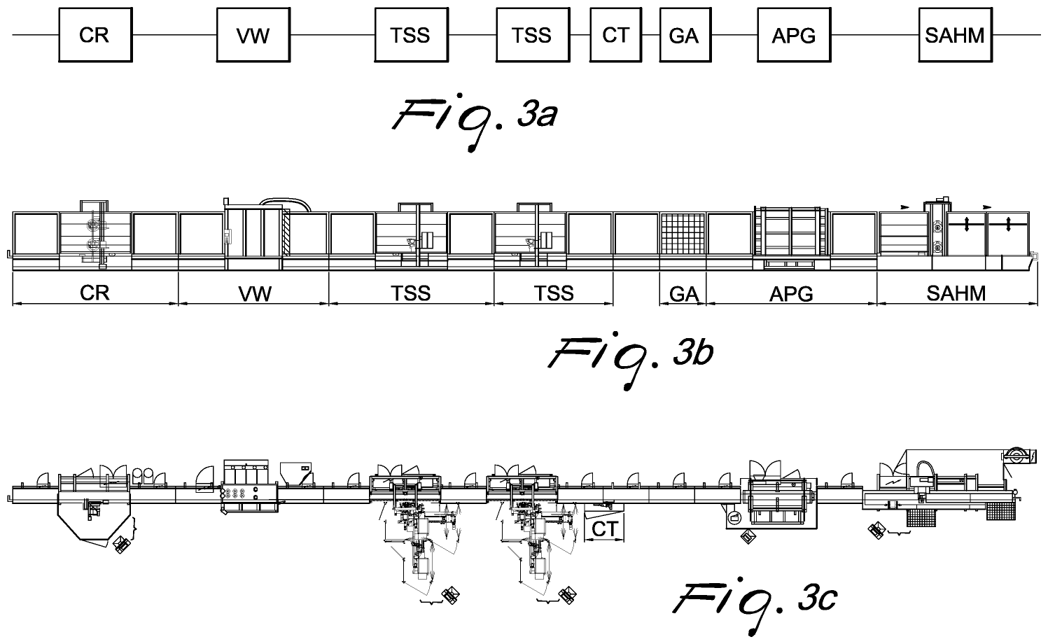

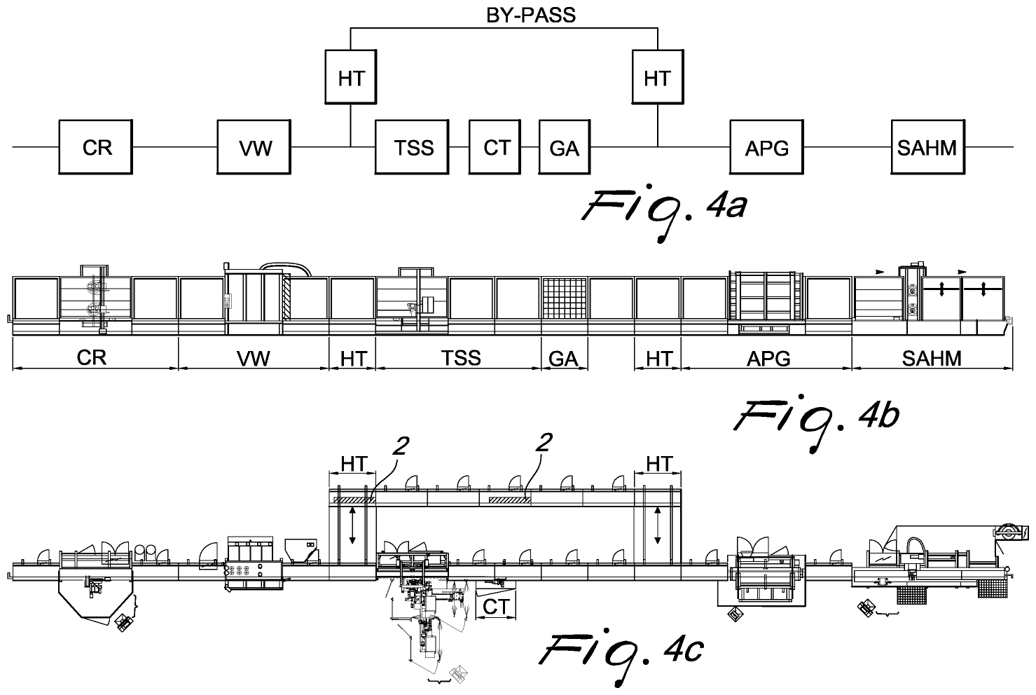

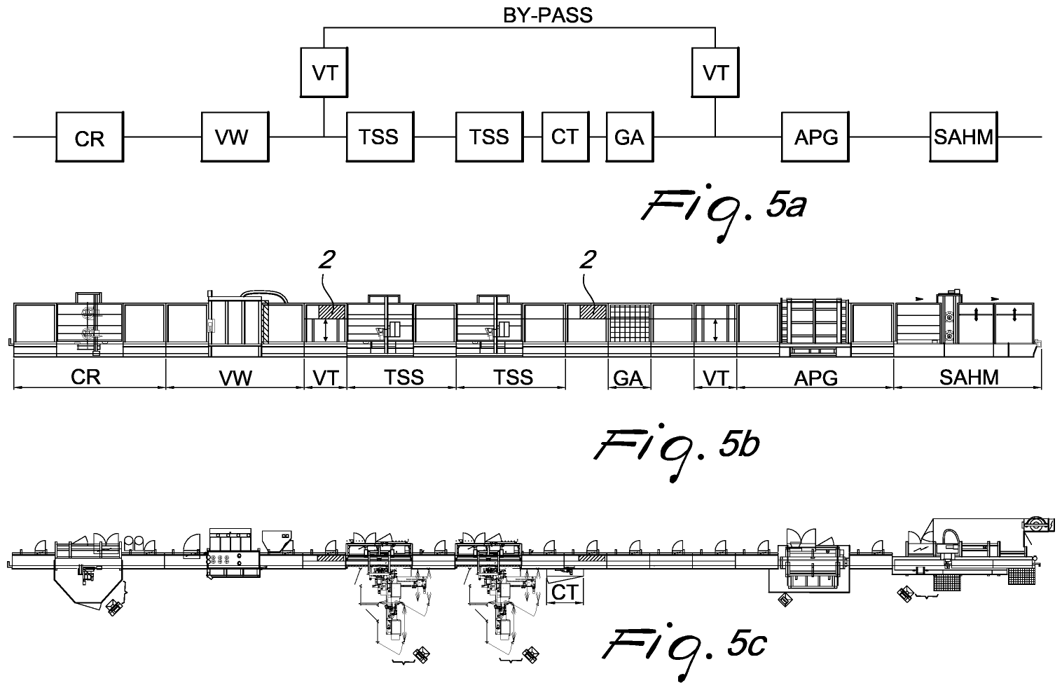

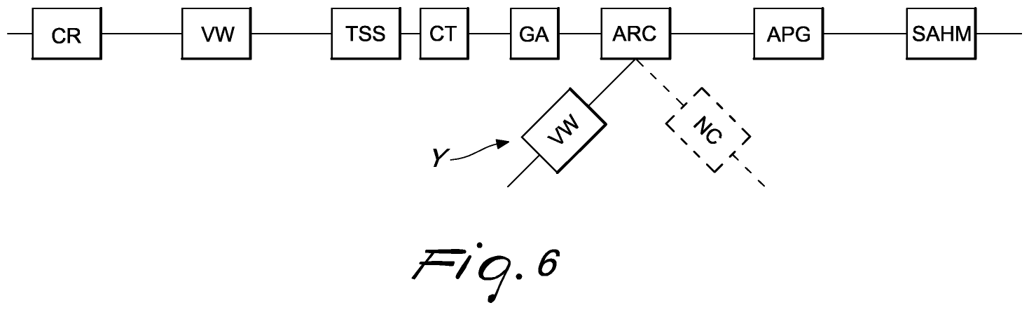

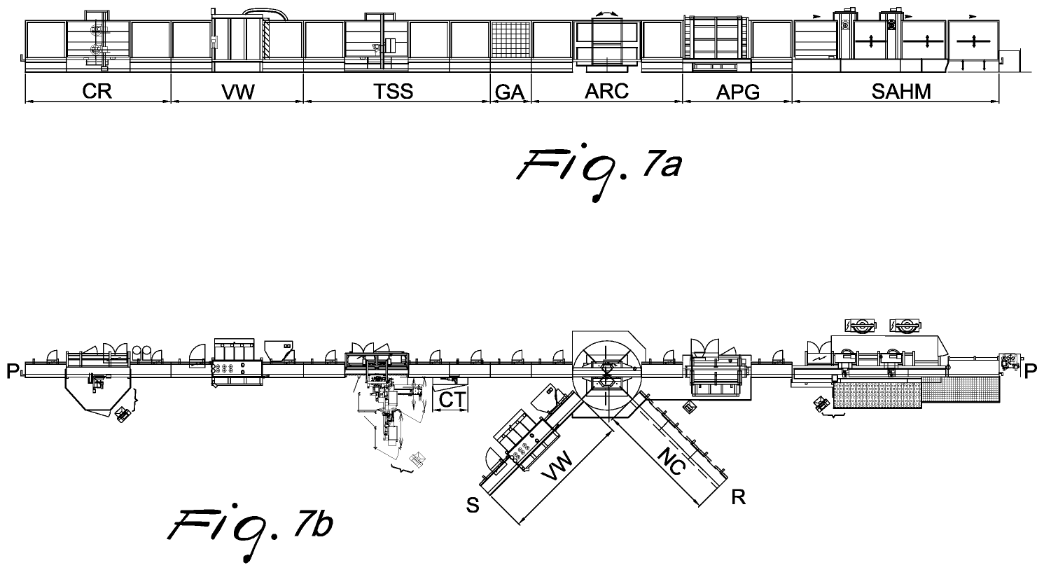

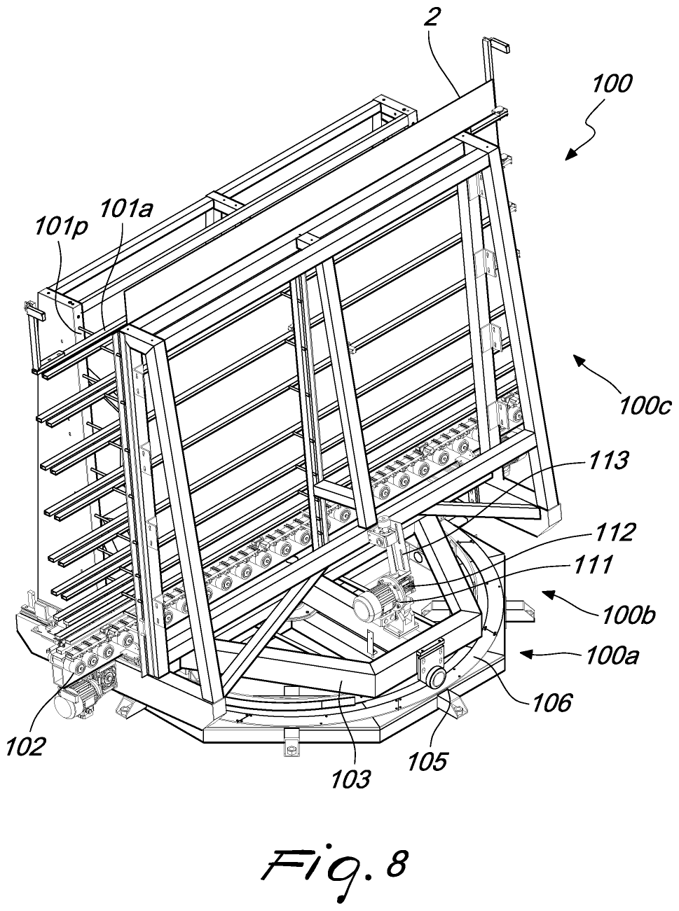

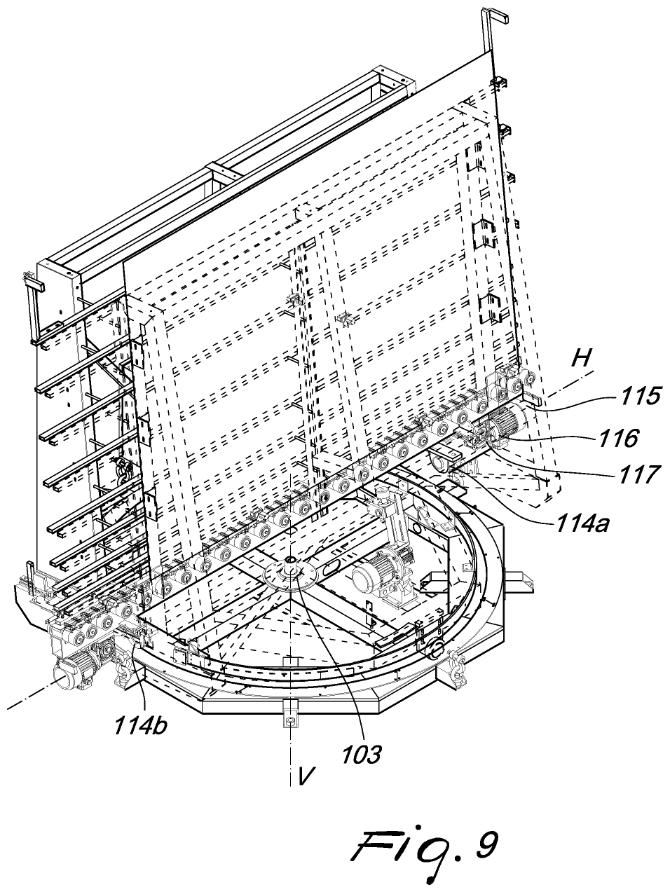

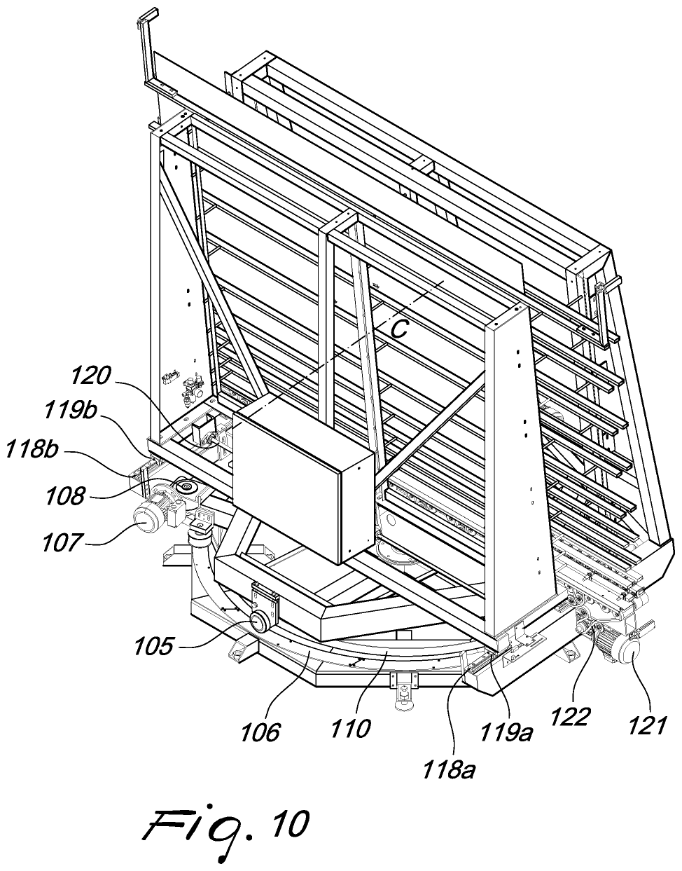

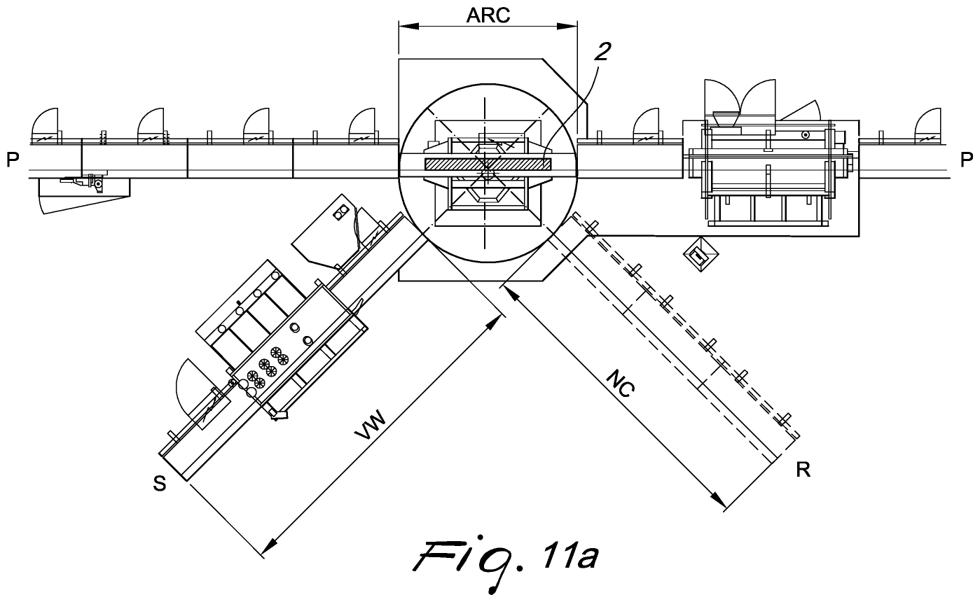

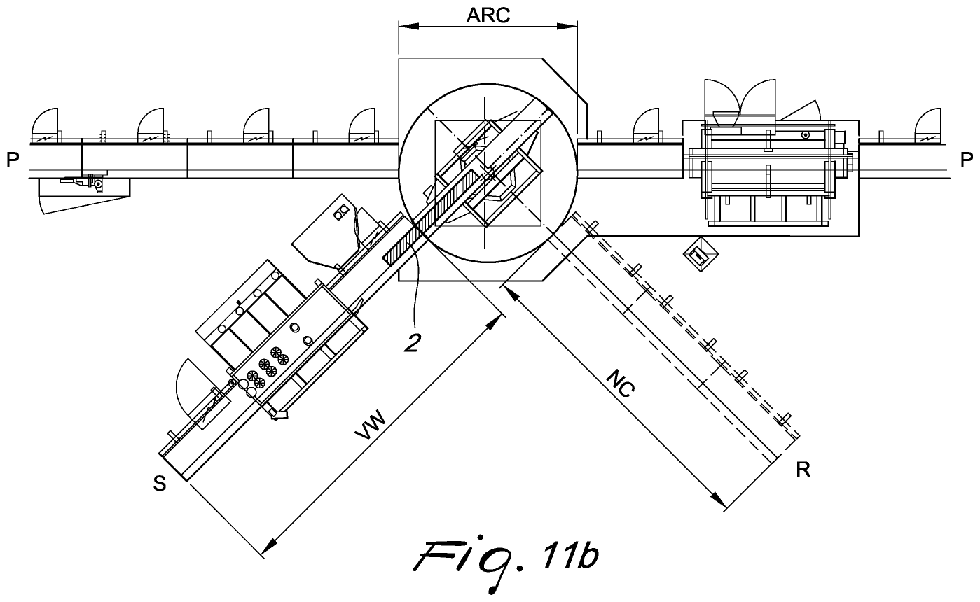

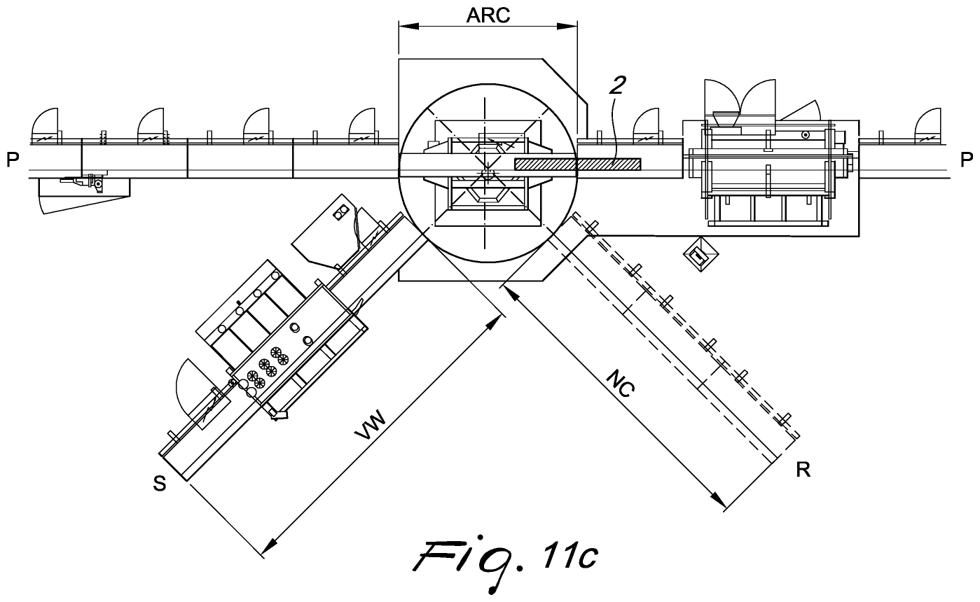

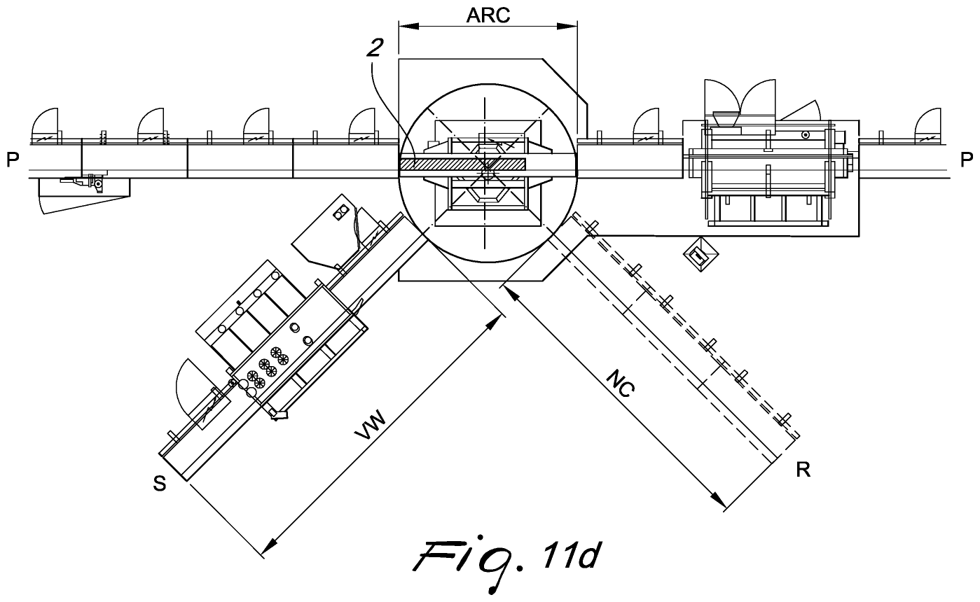

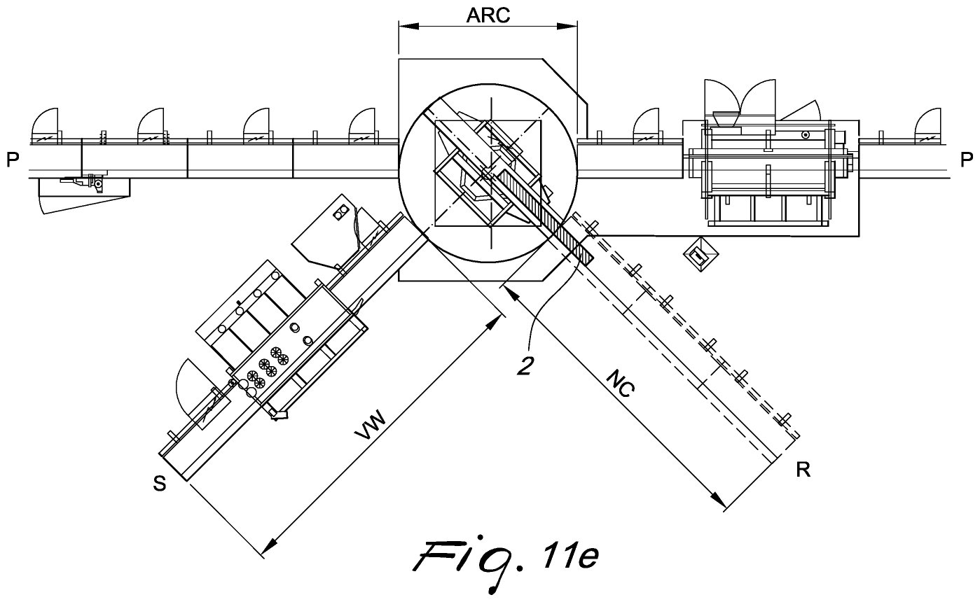

In the situation of FIGS. 1H and 1L, the hygroscopic material 4 is embedded in the mass that constitutes the spacer profile 3 at the time of its manufacture.

The inside/outside orientation is identified visually with icons which represent the sun (outer side) and the radiator (inner side).

These FIGS. 1A-1L show that the insulating glazing unit 1 can have multiple shapes and that along the production line of the insulating glazing unit glass sheets 2 of the first type and glass sheets of the second type must coexist, since both types are almost always present in the same insulating glazing unit.

FIGS. 2a, 2b and 2c illustrate the background art, both as a block diagram (the blocks simulating the machine bodies), and as a composition of machines, with an elevation and plan view, related to the traditional insulating glazing unit production line having standard productivity.

FIGS. 3a, 3b and 3c illustrate the background art, both as a block diagram (the blocks simulating the machine bodies), and as a composition of machines, with an elevation and plan view, related to the traditional insulating glazing unit production line having high productivity.

FIGS. 4a, 4b and 4c illustrate the most recent background art, both as a block diagram (the blocks simulating the machine bodies), and as a composition of machines, with an elevation and plan view, related to the innovative insulating glazing unit production line having high productivity, shuttle system (Erdman).

The acronym HT stands for “horizontal transfer” (actuated by means of shuttles that move transversely, with respect to the plane of the line, the glass sheets 2 of the second type on a rear longitudinal transport conveyor that is coplanar with the main one).

FIGS. 5a, 5b and 5c illustrate the most recent background art, both as a block diagram (the blocks simulating the machine bodies), and as a composition of machines, with an elevation and plan view, related to the innovative insulating glazing unit production line having high productivity, bridge system (Lisec).

The acronym VT stands for “vertical transfer” (actuated by means of lifting feet which move, in the plane of the line and vertically, the glass sheets 2 of the second type on an upper longitudinal transport conveyor that is parallel to the main one).

FIG. 6 is the block diagram of the solution according to the present invention.

FIGS. 7a and 7b are elevation and plan views of the distribution of the machines according to the solution of the present invention, a distribution that can be termed “Y-shaped”, since a merging between the secondary line and the main line is used.

FIGS. 8, 9 and 10 are views of the oscillating conveyor that provides the “Y” node for merging the secondary line with the main line, respectively in the following views: front view, front view with some structures shown in dashes in order to make the inner and rear parts visible.

FIGS. 11a-11e are views of the arrangement of the oscillating conveyor in the respective situations: transit of a glass sheet of the first type; merging of a glass sheet of the second type; routing of said glass sheet of the second type; reversal of the arrangement of a sheet of the first type; expulsion of a glass sheet of the first or second type because it has to be discarded; the glass sheet 2 is shown, in each situation, in dashes and viewed downward from above, i.e., comprising in projection the effect of the inclination by 5÷10 degrees.

For all the figures, where applicable, the following acronyms (derived from the corresponding terms in English) are used, referring to the process performed by the respective machine:

### CR=EDGING

### VW=WASHING

### TSS=SPACER FRAME PLACEMENT

### CT=CLOSING OF 4TH CORNER

### GA=GRILLE APPLICATION

### APG=FILLING WITH GAS, MATING AND PRESSING

### SAHM=SECOND SEALING

### HT=HORIZONTAL TRANSFER

### VT=VERTICAL TRANSFER

### ARC=OSCILLATING CONVEYOR

### NC=CONVEYOR FOR NONCONFORMING GLASS SHEETS

### P=MAIN LINE

### S=SECONDARY LINE

### R=REJECT LINE

The grinding step is not considered because it is required increasingly often in the complete version of full processing of the perimetric edge, i.e., over the entire thickness, and this requires moderate relative speeds between the tool and the glass sheet 2, and with a finishing which also entails tools changing, with the consequence of considerable cycle times; this step, therefore, is performed in machines which are external with respect to those of the production line of the insulating glazing unit 1, in order to avoid compromising the productivity of the apparatus, a productivity which, among the aim and objects of the present invention, is required to be high.

### DESCRIPTION OF PREFERRED EMBODIMENTS

A preferred method of providing the invention is the one of the block diagram of FIG. 6 and of the illustration of the machines of FIGS. 7a and 7b.

The path of the glass sheets of the first type, for a predominant part of the line, is kept not intersected or alternated by the path of the glass sheets of the second type and therefore the machines that perform the processings thereof (for example: perimetric removal of the nanocoating, application of the spacer frame, optional closing of its fourth corner in the case of a flexible profile, insertion of the grille), which instead do not involve the glass sheets of the second type, are optimized in terms of productivity.

Only at the merging point, indicated with “Y” in the mentioned figures, the glass sheets of the second type join the process, and this is optimum because the composition of the insulating glazing unit involves, only from that point onward, all the sheets for the processes of assembly, gas filling, pressing, and second sealing. The glass sheets of the second type merge at the “Y” merging point, after undergoing only the washing process, through an oscillating conveyor 100 that is aligned alternately either with the conveyors of the main path (main line P) or with the conveyor of the merging branch (secondary line S).

Apparently, in the line as a whole the washing machines are doubled, but since each one of them is used for a lower productivity, actually it is of a simpler type.

The use of labor for the feeding of the glass sheets (obviously in the case in which automation or robotics for loading are not used) remains unchanged, because instead of using the two operators at the beginning of the traditional high-productivity line, who moreover in this situation must follows a sometime complex sequence of loadings of the sheets of the first type and of the second type, they are stationed one at the beginning of the main line P and one at the beginning of the secondary line S (for merging) and are considerably facilitated in the loading logic, since the two types of glass sheet are physically separated.

These are the operating sequences of the line, referred to the type of insulating glazing unit of FIG. 1H, for which substantially all the typical processing stations, as described in the BACKGROUND ART chapter, are involved.

A premise regarding orientations must be kept in mind: the expression “substantially vertical” is understood to mean “slightly inclined with respect to the vertical”; in fact transport of the insulating glazing unit 1 occurs on conveyors the resting plane of which is inclined by approximately 6 degrees (5÷10 degrees) with respect to the vertical plane, and likewise the rollers or other lower supporting/transport elements have their axis inclined by approximately 6 degrees (5÷10 degrees) with respect to the horizontal plane, therefore when mention has been or will be made of “substantially horizontal”, “slightly inclined with respect to the horizontal” has been and will be intended.

With reference to FIG. 7, the glass sheet 2 of the first type is loaded, either manually or by means of a robot, in the inlet conveyor (left portion) of the main line and progressively undergoes the processes of: edging, washing, spacer frame laying, optional closure of its fourth corner in the case of a flexible profile, laying of the grille; while the glass sheet 2 of the second type arrives from the secondary line, along which it undergoes only the washing process, which merges into the main line.

The merging section is constituted by the oscillating conveyor 100, which is aligned, alternately and with a sequence managed by a programmable logic controller, either with the main line P for the transit of the glass sheets 2 of the first type or with the secondary line S for the merging and subsequent transit of the glass sheets 2 of the second type.

Moreover, said oscillating conveyor 100, in a configuration with suitable oscillation breadth, performs two further important functions:

# expulsion of the nonconforming glass sheets of the first type and second type, which otherwise would have to be unloaded manually along the main line or taken to the end of the main line and unloaded there;

# reversal of the orientation of the glass sheets of the second type (which in this unique case cannot be loaded from the secondary line S since they have to undergo edging and therefore become of the first type), by means of a 180-degree rotation, typically in order to reverse the arrangement of the glass face that bears the nanocoating, which for the process of peripheral removal (first machine of the series shown in FIGS. 7b and 7c) faces the working head, i.e., the operator, while for the subsequent processes, such as coupling with the other glass sheet or sheets in the composition of the insulating glazing unit 1, must face the conveyors (typical cases of FIGS. 1F and 1H, but not only), since this is the only possibility to obtain the necessary combination of the glass sheets 2 in the insulating glazing unit 1.

While the machines that constitute the main line P are part of the described background art and perform the processes that are also known and described in the BACKGROUND ART paragraph, and the washing machine of the arm of the secondary line S is part of this described background art too, the composition and the characteristics of the oscillating conveyor 100, in view of its function of constituting the “Y” node according to the inventive concept of the present invention, which modifies the sequence of the flow of the glass sheets 2 of the first type and the glass sheets 2 of the second type, are described hereinafter.

In FIGS. 7b, 11a-11e, the node “Y” is shown with an inclined convergence of the secondary line S toward the main line P, hence the “Y” designation, we might designate this node as “T” node if this convergence is at 90°, although this is irrelevant for the purpose of the inventive concept.

The oscillating conveyor is divided essentially into a rear plane 101p, with a front plane 101a arranged opposite, both with a substantially vertical arrangement, for the resting and idle sliding of the glass sheets 2, and a conveyor 102, with a substantially horizontal arrangement, for the resting and motorized transport of the glass sheets 2, generally of the type with rollers or a belt, which cooperates with the rear plane 101p, the latter being adjustable while remaining parallel to itself along the direction C.

The planes 101a and 101p, moreover, can undergo an adjustment with respect to the vertical arrangement (here designated as truly vertical) in both directions, so that the resting and idle sliding planes, as well as the conveyor 102, can align themselves in a coplanar manner with the arrangement of the corresponding elements of the main line P in the alternating situations of the intermediate body 100b in 0 degree and 180 degree phase with respect to the main line P during the oscillation of said intermediate body 100b with respect to the footing 100a about the axis V.

As a whole, the upper body 100c and the intermediate body 100b constitute the oscillating part of the conveyor 100 on the footing 100a.

The oscillation of said intermediate body 100b, with respect to the footing 100a, about the axis V, in order to align said intermediate body 100b, in the 0 degree and 180 degree phases with respect to the main line as mentioned earlier and also in order to align said intermediate body 100b with the secondary merging line S and with the module NC for rejecting the defective sheets, is performed by rotating, about the pivot 103, the structure 104 provided with wheels 105 which run on the track 106 by means of the motor 107, which by means of the reduction gear 108 and the toothed pulley 109 (which is not visible and is not designated by numerals in the figures, but can be deduced) makes the entire intermediate body 100b oscillate with respect to the footing 100a by acting on the toothed belt 110, the ends of which and the containment track of which are integral with the footing 100a.

In the 0 degree and 180 degree phases (the second one being used in order to obtain the orientation of the face bearing the low-emissivity coating that is suitable for the type of insulating glazing unit to be manufactured, by way of non-exhaustive example one of those shown in FIGS. 1A-1L, particularly the ones of Figures IF, 1H), respectively the planes 101p and 101a must be aligned in a coplanar manner with the arrangement of the corresponding planes of the main line P, upstream if the glass sheet is being received at the oscillating conveyor, downstream if the glass sheet is being expelled from the oscillating conveyor (although these two arrangements are typically identical), or with the secondary line S, or with the line R for expelling the nonconforming NC glass sheets 2. For this purpose, the kinematic system constituted by the following is provided: motor 111, reduction gear 112, screw/female thread assembly 113 that actuates the tilting of the rear plane 101p/front plane 101a unit about the longitudinal axis H identified by the pivots 114a, 114b.

A further kinematic system is necessary in order to adapt the placement of the rear plane 101p, which in the 0 degree phase is at the rear stroke limit which corresponds to the alignment in coplanar mode with the conveyors of the main line P, to the thickness of the glass sheet 2, the need for adaptation deriving from the need to deposit the glass sheet 2 on the front plane 101a when it changes its angular phase by 180°, i.e., if said glass sheet 2 must be reversed in its arrangement. During the tilting about the axis H, the distance between the rear plane 101p and the front plane 101a must in fact correspond to the thickness of the glass sheet 2, increased by a small clearance, in order to avoid shocks affecting the same sheet, which would be damaged and would not be coplanar with the downstream conveyor.

This kinematic system is constituted by the following actuators and components: motor 115, reduction unit 116, mechanical transmission 117, guides 118a, 118b, ball bearing sliders 119a, 119b, torsion bar 120 complete with gears and racks, kinematic system which adjusts the position of the rear plane 101p with respect to the front plane 101a along the transverse axis C.

To summarize, the essential mechanical components that identify the oscillation axis V (vertical), the tilting axis H (horizontal) and the adjustment axis C (transverse) are respectively; for the axis V, the pivot 103, which is integral with the footing 100a, interacting with the structure 104 of the intermediate body 100b; for the axis H, the pivots 114a, 114b, interacting between the structure 104 of the intermediate body 100b and the upper body 100c; for the axis C, the guides 118a, 118b.

As regards the conveyor 102, its motor drive belongs to the background art used in all the conveyors of the main line, regardless of whether they are of the roller or belt type, and consists essentially of the gearmotor 121 and the kinematic system 122, for example constituted by a chain and pinions.

Of course, all the movements connected to the steps of the cycle are mutually interlocked, with the aid of a logic system that is parallel but always active, in order to avoid, during the process, conditions of mutual interference between actuating elements and material being processed, except for those specific for the process.

Nevertheless, particular attention is given to the safety devices, for preventing injuries; such devices, shown schematically in FIGS. 2c, 3c, 4c, 5c, 7b, consisting of fixed barriers, interlocked movable barriers, optical barriers, electrosensitive mats, etcetera.

The present invention is susceptible of numerous constructive variations (with respect to what can be deduced from the drawings, the details of which are clear and eloquent), all of which are within the scope of the appended claims; thus, for example, the mechanical solutions for the handling and the adjustments of the oscillating/tilting conveyor, the electronic/mechanical solutions for them, etcetera, the actuation means, which can be electric, electrical-electronic, pneumatic, hydraulic and/or combined, etcetera, the control means that can be electronic or fluidic and/or combined, etcetera.

The constructive details may be replaced with other technically equivalent ones.

The materials and the dimensions may be any according to the requirements, particularly arising from the dimensions (base, height and thicknesses) and/or from the shape of the insulating glazing unit 1 to be produced starting from its components: glass sheets 2, spacer profile 3, hygroscopic material 4, sealants 5 (where present), 6, any gas 7, adhesive 8 (where present), grille 9 (where present).

The description and the figures cited above refer to lines located according to a left-to-right process flow; it is easy to imagine a description and corresponding figures in the case of mirror-symmetrical or otherwise different arrangements, for example that include variations in the direction of the line.

### INDUSTRIAL APPLICATION

The industrial application is of assured interest, since insulating glazing unit production lines are by now configured for the manufacture of the multiple insulating glazing unit configurations, as presented in the first part of the description and partly exemplified in FIG. 1, i.e., they comprise a complete and complex variety of machines that is adapted to obtain all the required processes, but this has caused an implosion of the system, since some of the glass sheets, despite not needing some specific processes, nevertheless travel through the corresponding machines because they are in any case in series with respect to those that are instead necessary for the entirety of the process.

This implosion consists in the limitation of the cycle time, which, although improved in the past by increasing the process speeds, now is regressing due to the inactivity of some machines caused by the steps of mere transit of the glass sheets defined in the description as of the second type, which cause steps of waiting for the glass sheets of the first type that are intended instead for the corresponding process. On the contrary, since market trends are oriented toward the reduction of final product costs, insulating glazing unit production lines are required to be increasingly high-performing in terms of productivity, flexibility and optimization of the process. As regards productivity, while the typical values of the past were in the range of 500 units for shift, during the last two years the demand has almost tripled, hence the new type of lines described as the most recent background art. The present invention therefore enters, with further advantages, a market situation that is particularly rising, since insulating glazing units are increasingly in demand in relation to the requirements of buildings with high thermal and sound insulation, with safety for accident prevention, intrusion prevention, vandalism prevention, etcetera, but at the same time in a condition of price competitiveness, imposing such mentioned high-performing characteristics. And the solution according to the present invention is certainly at such a level of competitiveness that it is preferred with respect to the solutions, however innovative, proposed by the competition in the described recent background art.

The disclosures in Italian Patent Application No. 102017000071422 from which this application claims priority are incorporated herein by reference.

Where technical features mentioned in any claim are followed by reference signs, those reference signs have been included for the sole purpose of increasing the intelligibility of the claims and accordingly, such reference signs do not have any limiting effect on the interpretation of each element identified by way of example by such reference signs.

1. A high-productivity line for the automatic production of panels of an insulating glazing unit composed of at least two glass sheets and at least one spacer frame interposed between said glass sheets in a peripheral position, which delimit a closed internal volume in which the air is usually replaced with a gas and delimit an outer peripheral region or joint, along which one or more sealing/adhesive products applied between the faces of said glass sheets and of said spacer frame give tightness and stability to the joint, of said glass sheets at least one, indicated as of the second type, being subjected to a smaller quantity of processes than the other or others of said glass sheets, indicated as of the first type, wherein the sheet or sheets of said glass sheets of the second type, subjected to said smaller quantity of processes, converge, by means of an oscillating conveyor, from a secondary line for the washing process in a main line for the process of edging, washing, laying of said spacer frame, optional closing of its fourth corner in the case of a flexible profile, placement of a grille only where and when their involvement begins, jointly with said glass sheets of the first type, in the composition of said insulating glazing unit.

2. The line according to claim 1, wherein the convergence between said secondary line and said main line is constituted by a Y-shaped coupling.

3. The line according to claim 1, wherein the convergence between said secondary line and said main line is constituted by a T-shaped coupling.

4. The line according to claim 1, wherein said oscillating conveyor constitutes alternately an element for the transit of said glass sheets of the first type in said main line and for the coupling of said glass sheets of the second type that arrive from said secondary line.

5. The line according to claim 4, wherein said oscillating conveyor also performs the function of expulsion, toward a reject line, of said glass sheets of the first type or of the second type that are contaminated by defects that prevent their use and therefore are nonconforming, and are indicated as NC.

6. The line according to claim 4, wherein said oscillating conveyor, by means of a 180° oscillation, also performs the function of reversing the arrangement of said glass sheets of the first type and optionally of the second type, in order to orient the face provided with nanocoating or with other surface treatments or other characteristics based on the orientation of the faces required for the composition of said insulating glazing unit.

7. An automatic method for the composition of an insulating glazing unit, the components of which are at least glass sheets, a spacer frame, one or more sealants/adhesives, and optionally other auxiliary components such as grilles, of said glass sheets at least one, indicated as of the second type, being subjected to a smaller quantity of processes than the other or others of said glass sheets, indicated as of the first type, wherein said glass sheet or sheets of the second type, subjected to said smaller quantity of processes, converge from a secondary line for the washing process in a main line for the process of edging, washing, laying of said spacer frame, optional closure of its fourth corner in the case of a flexible profile, placement of a grille only where and when their involvement begins, jointly with said glass sheets of the first type, in the composition of said insulating glazing unit.

8. The method according to claim 7, wherein the convergence region can also perform the function of unloading said glass sheets that are contaminated by defects that prevent their use and therefore are nonconforming and indicated as NC.

9. The method according to claim 7, wherein the convergence region between said secondary line and said main line can also perform the function of reversing the arrangement of said glass sheets in order to orient the face optionally provided with nanocoating or with other surface treatments or other characteristics according to the orientation of the faces that is required for the composition of said insulating glazing unit.
